(19) United States
(12) Patent Application Publication
(10) Pub. No.: US 2026/0012029 A1
(43) Pub. Date: Jan. 8, 2026

(54) Cordless Battery-Powered Kitchen Appliance System

(71) Applicant: Ralph Watson, Westfield, WI (US)

(72) Inventor: Ralph Watson, Westfield, WI (US)

(21) Appl. No.: 19/246,782

(22) Filed: Jun. 24, 2025

Related U.S. Application Data
(60) Provisional application No. 63/666,700, filed on Jul. 2, 2024.

(51) Int. Cl. H02J 7/00; H01M 10/42; H01M 10/48

(52) U.S. Cl. CPC H02J 7/0045; H01M 10/425; H01M 10/486; H02J 7/00036; H02J 7/0048; H01M 2010/4271; H02J 2310/14

(57) ABSTRACT

A cordless battery-powered kitchen appliance system is provided. The system is comprised of a rechargeable battery, at least one battery-powered appliance, and a modular battery charging station. The rechargeable battery may comprise a current sensing circuit, voltage regulation circuitry, a pre-charge control mechanism, embedded temperature sensors, a state-of-charge estimator, and a communication interface. The battery further comprises a male connector formed of conductive terminals and digital communication lines. The charging station comprises one or more female charging ports with recessed or spring-loaded contacts configured to interface with the battery connector. The charging station includes physical and electrical interconnection features to support modularity, allowing multiple charging stations to be attached and powered from a single source through a power supply interface. The appliance comprises a receiving area with conductive contacts configured to receive the battery and establish electrical connectivity.

### CROSS-REFERENCE TO RELATED APPLICATION

The present application claims priority to, and the benefit of, U.S. Provisional Application No. 63/666,700, which was filed on Jul. 2, 2024, and is incorporated herein by reference in its entirety.

### FIELD OF THE INVENTION

The present invention relates generally to the field of appliances. More specifically, the present invention relates to a rechargeable battery used to power an appliance without the need for an electrical outlet. A modular charging station recharges the battery and allows multiple charging stations to connect and receive power from a single power source. Accordingly, the present disclosure makes specific reference thereto. Nonetheless, it is to be appreciated that aspects of the present invention are also equally applicable to other like applications, devices, and methods of manufacture.

### BACKGROUND

Traditional kitchen appliances such as microwaves, toasters, and coffee makers rely on fixed electrical power sources to operate. These appliances require direct connection to wall outlets, which are often limited in number and inconveniently located in many kitchen environments. During power outages, users are unable to utilize these appliances, disrupting food and beverage preparation. Additionally, managing numerous power cords can lead to cluttered countertops, tangled cables in storage drawers, and overall reduced kitchen efficiency. This situation is particularly problematic in compact kitchens or settings where multiple appliances are stored together. Furthermore, the stationary nature of corded appliances limits mobility and adaptability, making them unsuitable for off-grid or emergency situations. The reliance on electrical outlets not only restricts appliance usability during outages but also increases setup time and reduces workspace flexibility.

Therefore, there exists a long-felt need in the art for a cordless battery-powered kitchen appliance system that operates independently of electrical outlets during power outages. There also exists a long-felt need in the art for a cordless battery-powered kitchen appliance system that provides modular charging capabilities to accommodate multiple rechargeable batteries. Moreover, there exists a long-felt need in the art for a cordless battery-powered kitchen appliance system that powers a wide variety of kitchen appliances with consistent voltage and capacity options.

The subject matter disclosed and claimed herein, in one embodiment thereof, comprises a cordless battery-powered kitchen appliance system. The system is comprised of a rechargeable battery, at least one battery-powered appliance, and a modular battery charging station. The rechargeable battery may comprise a current sensing circuit, voltage regulation circuitry, a pre-charge control mechanism, embedded temperature sensors, a state-of-charge estimator, and a communication interface. The battery further comprises a male connector formed of conductive terminals and digital communication lines. The charging station comprises one or more female charging ports with recessed or spring-loaded contacts configured to interface with the battery connector. The charging station includes physical and electrical interconnection features to support modularity, allowing multiple charging stations to be attached and powered from a single source through a power supply interface. The appliance comprises a receiving area with conductive contacts configured to receive the battery and establish electrical connectivity.

In this manner, the cordless battery-powered kitchen appliance system of the present invention accomplishes all the forgoing objectives and provides a power-independent solution that enables uninterrupted operation of kitchen appliances during electrical outages. The modular charging station further fulfills the need for scalable battery management by supporting simultaneous recharging of multiple batteries through a shared power interface. The system further addresses operational flexibility by accommodating appliances with varying voltage and capacity requirements, thereby supporting a broad spectrum of use scenarios. As a result, the system reduces physical clutter, eliminates the need to search for available outlets, and supports appliance usage in grid-connected and off-grid settings, thereby enhancing overall appliance functionality.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a cordless battery-powered kitchen appliance system. The system is comprised of a rechargeable battery, a battery-powered appliance, and at least one modular charging station configured to recharge the battery. The system is designed for use in domestic, commercial, industrial, and mobile applications where conventional power supplies may not be available.

The rechargeable battery is comprised of a housing containing one or more electrochemical cells. The battery is further comprised of components for managing charging and discharging, including a current sensing circuit, a voltage regulation circuit, a pre-charge circuit, temperature sensors, a state-of-charge estimator, and a communication interface. A male connector on the battery is comprised of conductive interfaces for power transfer, additional interfaces for digital communication, and alignment features for proper engagement with the charging station.

Each charging station is comprised of a female charging port with attachment interfaces to receive the male connector of the battery. The charging ports are designed to match different battery voltage specifications in different embodiments. The charging stations are modular and physically and electrically interconnectable using reciprocating fasteners and connection interfaces. This allows a primary charging station to distribute power and digital signals to attached secondary stations. The primary charging station is comprised of a power supply interface compatible with AC or DC inputs. Subsequent stations rely on power distributed from the primary unit. Each charging station may include a battery management module comprising a microcontroller or power management IC, voltage, current, and temperature sensors, and protection circuits that provide safety and operational control.

The appliance is comprised of a receiving area with integrated electrical contacts aligned to interface with the male connector of the battery. Appliances powered by the system may include kitchen appliances, personal care devices, or utility tools, allowing flexibility across various types and configurations.

Accordingly, the cordless battery-powered kitchen appliance system of the present invention is particularly advantageous as it enables uninterrupted operation of kitchen appliances during electrical outages. The modular charging station further fulfills the need for scalable battery management by supporting simultaneous recharging of multiple batteries through a shared power interface. The system further addresses operational flexibility by accommodating appliances with varying voltage and capacity requirements, thereby supporting a broad spectrum of use scenarios. As a result, the system reduces physical clutter, eliminates the need to search for available outlets, and supports appliance usage in grid-connected and off-grid settings, thereby enhancing overall appliance functionality. In this manner, the cordless battery-powered kitchen appliance system overcomes the limitations of existing appliances known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side view of a battery of one potential embodiment of a cordless battery-powered kitchen appliance system of the present invention in accordance with the disclosed architecture;

FIG. 2 illustrates a perspective view of multiple configurations of charging stations of one potential embodiment of a cordless battery-powered kitchen appliance system of the present invention in accordance with the disclosed architecture;

FIG. 3 illustrates a perspective views of appliances of one potential embodiment of a cordless battery-powered kitchen appliance system of the present invention with a battery attached to one appliance in accordance with the disclosed architecture;

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a cordless battery-powered kitchen appliance system that operates independently of electrical outlets during power outages. There also exists a long-felt need in the art for a cordless battery-powered kitchen appliance system that provides modular charging capabilities to accommodate multiple rechargeable batteries. Moreover, there exists a long-felt need in the art for a cordless battery-powered kitchen appliance system that powers a wide variety of kitchen appliances with consistent voltage and capacity options.

The present invention, in one exemplary embodiment, is comprised of a cordless battery-powered kitchen appliance system. The system includes a rechargeable battery, a battery-powered appliance, and at least one modular charging station that is configured to recharge the battery. The system is designed for domestic, commercial, industrial, and mobile environments and enables operation where standard power sources may not be available.

The rechargeable battery features a housing that encloses one or more electrochemical cells. Integrated within the battery are components that manage charging and discharging processes, including a current sensing circuit, a voltage regulation circuit, a pre-charge circuit, temperature sensors, a state-of-charge estimator, and a communication interface. A male connector extends from the battery, comprising conductive interfaces for power delivery, communication interfaces for digital data transfer, and alignment features to ensure proper connection with the charging station.

Each charging station features a female charging port equipped with attachment interfaces to accommodate the battery's male connector. Charging ports are configured to support various voltage specifications depending on the embodiment. The charging stations can be physically and electrically interconnected through reciprocating fasteners and connection interfaces, enabling a primary charging station to supply power and data to additional connected units. The primary station includes a power supply interface capable of accepting AC or DC input, while the secondary stations receive distributed power from the primary unit. Each station may also include a battery management module comprising a microcontroller or power management IC, as well as voltage, current, and temperature sensors, and protective circuits to ensure safe operation.

The appliance integrates a receiving area containing electrical contacts positioned to align with and engage the battery's male connector. Compatible appliances span various categories, including kitchen appliances, personal care devices, and utility tools, supporting a wide range of operational configurations.

As a result, the device provides significant advantages, including continuous appliance functionality during power outages. The modular charging station enables scalable battery management by supporting simultaneous charging of multiple batteries through a unified power interface. The system accommodates a variety of appliances with differing voltage and capacity requirements, enhancing its suitability across diverse applications. Additionally, the system minimizes physical clutter, eliminates dependence on wall outlets, and supports both grid-connected and off-grid use, thereby improving appliance utility and overcoming limitations found in prior solutions and devices.

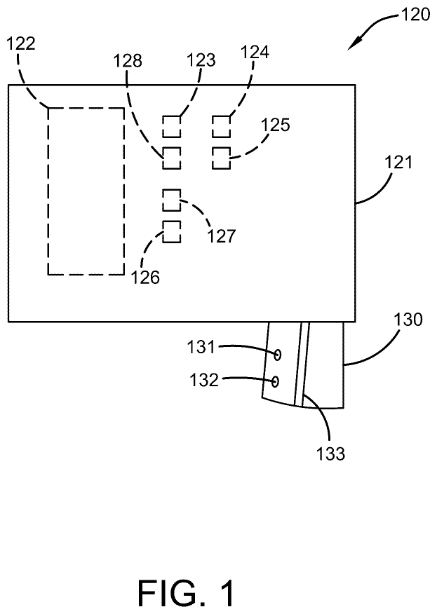

Referring initially to the drawings, FIG. 1 illustrates a side view of a battery 120 of one potential embodiment of a cordless battery-powered kitchen appliance system 100 of the present invention in accordance with the disclosed architecture. The system 100 may be comprised of a combination of a rechargeable battery 120, a battery-powered appliance 140 powered by the rechargeable battery 120, and at least one modular battery charging station 160 that recharges the rechargeable battery 120. The system 100 may be designed to power appliances 140 across a range of use scenarios, including domestic, commercial, industrial, and mobile applications where standard power supplies are unavailable.

The rechargeable battery 120 may be comprised of a housing 121 enclosing one or more rechargeable electrochemical cells 122, as seen in FIG. 1. The cells 122 may be of any type such as but not limited to lithium-ion, lithium-polymer, nickel-metal hydride, or solid-state chemistries. In one embodiment, the battery 120 may operate at a voltage of 12V. In another embodiment, the battery 120 may operate at a voltage of 20V. The capacity of the batteries 120 in this embodiment ranges from 2 to 6 amp-hours. In additional configurations, the voltage may range from 5V to 60V, and capacity may vary from under 1 amp-hour to over 10 amp-hours, depending on the requirements of the appliance 140 that the battery 120 is intended to power.

The battery 120 may be comprised of a plurality of additional components to manage charging, discharging, and communication, as seen in FIG. 1. More specifically, the battery may include a current sensing circuit 123 configured to monitor electrical current flow for overload detection, current limiting, and charge tracking. The battery 120 may also be comprised of a voltage regulation circuit 124 that may maintain stable voltage levels during power transfer and prevents overvoltage conditions during charging. The battery 120 may further have a pre-charge circuit 125 may control the initial charging current when the battery is deeply discharged or under extreme thermal conditions, thereby ensuring gradual ramp-up and preventing electrical stress. In addition, the battery 120 may have one or more temperature sensors 126 that may be embedded in or near the cells 122 to monitor operating temperatures and trigger thermal protection responses. Furthermore, the battery 120 may be comprised of a state-of-charge estimator 127 that may determine remaining battery 120 capacity using methods such as coulomb counting or voltage-based estimation, providing accurate runtime predictions and guiding the charging process. A communication interface 128 such as but not limited to I²C, SMBus, or CAN may be included in the battery 120 exchange data between the battery and external systems.

The battery 120 is comprised of a male connector 130 that may be comprised of one or more conductive interfaces 131 formed from electrically conductive materials such as copper or gold-plated alloys, configured to deliver positive and negative terminals for charging. The conductive elements 131 may be accompanied by additional interfaces 132 for dedicated to digital communication lines for functions such as battery identification, state-of-charge reporting, and fault condition alerts. The male connector 130 may also include mechanical alignment features 133 such as but not limited to asymmetrical housings, keyed geometries, or magnetic positioning elements to ensure proper orientation and consistent engagement with the charging station 160.

More specifically, the charging station 160 is comprised of a female charging port 161 that may include attachment interfaces 162 such as but not limited to recessed contact sleeves or spring-loaded terminals configured to receive the conductive interfaces 131 of the male connector.

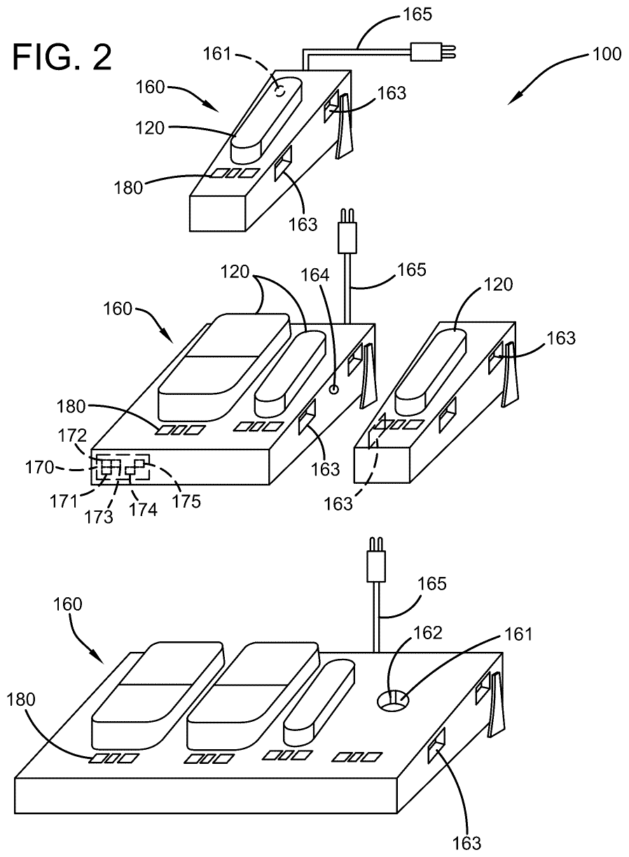

The system 100 may have one or more modular charging stations 160, each having at least one battery charging port 161, as seen in FIG. 2. As noted, each charging port 161 may be a female receptacle designed to accept the male connector 131 of each battery 120. The charging port 161 may correspond to specific battery voltages such as 12V, 20v, etc. in different embodiment.

The charging station 160 may support modularity through physical and electrical interconnection features. More specifically, two or more charging stations 160 can be attached to one another using a pair of reciprocating fasteners 163 such as but not limited to male and female fasteners, magnetic fasteners, snap-fit connectors, etc. found on either or both charging stations 160, as seen in FIG. 2. Both charging stations 160 are further electrically coupled with one another via connection interfaces 164 such as but not limited to edge contacts, multi-pin plugs, bus bar terminals, or flexible jumpers. These interfaces 164 may carry both power and digital signals between the stations 160, allowing one primary charging station 160 to receive external power and distribute said power across multiple secondary charging stations 160 that are subsequently attached to the primary charging station 160.

The primary charging station 160 may be equipped with a power supply interface 165 that may include a detachable AC cord, DC barrel jack, USB-C input, etc. In some embodiments, dual-input compatibility may allow simultaneous or alternate sourcing from AC and DC supplies. As noted, in the preferred embodiment, a first charging station 160 has a power supply interface 165, and subsequent charging stations 160 attached to the first charging station 160 do not, allowing multiple charging stations 160 to receive power from one power supply interface 165 of one charging station 160.

A battery management module 170 may be included in each charging station 160 comprised of a microcontroller/power management integrated circuit 171, voltage sensors 172, current sensors 173, temperature sensors 174, and protection circuits 175 as seen in FIG. 2. Protective functions of the module 170 may include but are not limited to thermal cutoff, overvoltage shutdown, undervoltage lockout, short circuit detection, and load balancing of the battery, appliance, and/or charging station.

In one embodiment, each charging station 160 is comprised of a display 180 to convey operational information. The display 180 may include numeric LCDs, OLED panels, LED bar indicators, or touchscreens. Displayed data on the display 180 may include charge percentage of an attached and charging battery 160, estimated battery charge time remaining, input voltage, charging current, system status, error messages, etc.

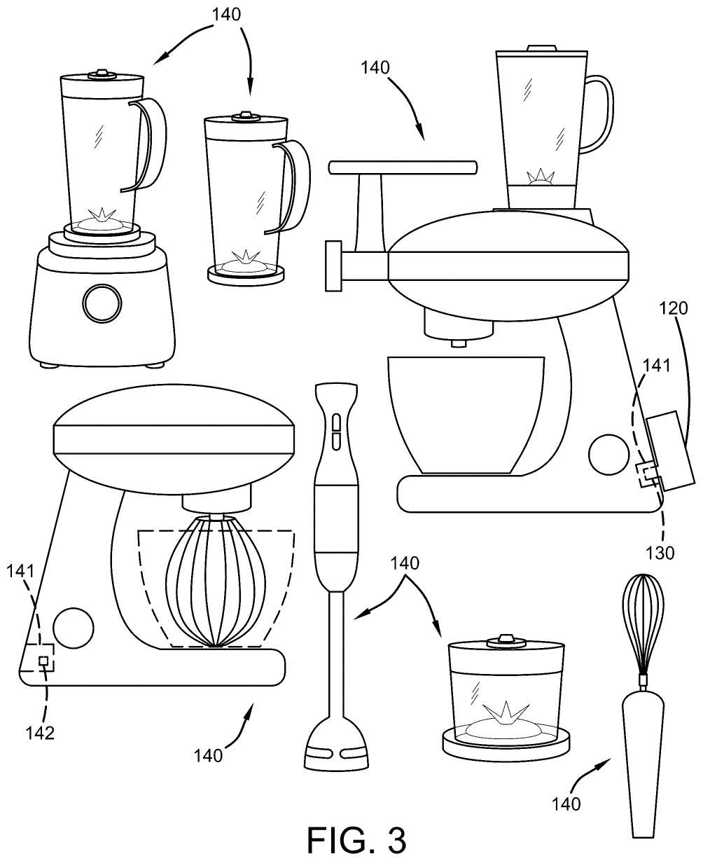

The appliance 140 of the system 100 may be comprised of a receiving area 141 that accommodates and retains the male connector 130 of the rechargeable battery 120, as seen in FIG. 3. The receiving area 141 may include integrated electrical contacts 142 designed to align with and receive the male connector 130. The contacts 142 may comprise recessed sleeves or spring-loaded terminals that establish electrical continuity with the interfaces 131. The contacts 142 may be fabricated from electrically conductive materials such as but not limited to beryllium copper or gold-plated alloys to enhance conductivity and resist corrosion over multiple cycles.

The appliance 140 may be comprised of any portable or stationary appliance or device, as shown by example in FIG. 3. In one embodiment, the appliance 140 may be a kitchen appliance such as but not limited to a blender, food processor, coffee grinder, hand mixer, electric can opener, etc. In another embodiment, the appliance 140 may be a personal care device such as but not limited to a toothbrush, hair trimmer, facial massager, or grooming tool. In other embodiments, the appliance 140 may be a utility or outdoor device such as but not limited to a cordless fan, work light, air inflator, garden trimmer, handheld vacuum, or power drill. It should be appreciated that the battery 120 can be used to power any type, structure, and configuration of portable or stationary appliance 140 or device in different embodiments.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “cordless battery-powered kitchen appliance system” and “system” are interchangeable and refer to the cordless battery-powered kitchen appliance system 100 of the present invention.

Notwithstanding the forgoing, the cordless battery-powered kitchen appliance system 100 of the present invention and its various components can be of any suitable size and configuration as is known in the art without affecting the overall concept of the invention, provided that they accomplish the above-stated objectives. One of ordinary skill in the art will appreciate that the size, configuration, and material of the cordless battery-powered kitchen appliance system 100 as shown in the FIGS. are for illustrative purposes only, and that many other sizes and shapes of the cordless battery-powered kitchen appliance system 100 are well within the scope of the present disclosure. Although the dimensions of the cordless battery-powered kitchen appliance system 100 are important design parameters for user convenience, the cordless battery-powered kitchen appliance system 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A cordless battery-powered kitchen appliance system comprising:
a first charging station comprised of:
a first charging port comprised of a first attachment interface;
a power supply interface configured to receive external power;
a first fastener;
a first electrical connection interface; and
a battery management module.

2. The cordless battery-powered kitchen appliance system of claim 1 further comprised of a second charging station comprised of a second fastener that attaches to the first fastener to allow the second charging station to attach to the first charging station.

3. The cordless battery-powered kitchen appliance system of claim 2, wherein the second charging station is comprised of a second charging port comprised of a second attachment interface.

4. The cordless battery-powered kitchen appliance system of claim 2, wherein the second charging station is comprised of a second electrical connection interface that engages the first electrical connection interface of the first charging station.

5. The cordless battery-powered kitchen appliance system of claim 1, wherein the battery management module is comprised of a temperature sensor.

6. The cordless battery-powered kitchen appliance system of claim 1, wherein the first charging station is comprised of a first display.

7. A cordless battery-powered kitchen appliance system comprising:
a first charging station comprised of:
a first charging port comprised of a first attachment interface;
a power supply interface configured to receive external power;
a first fastener;
a first electrical connection interface; and
a battery management module;
a rechargeable battery comprised of:
a housing;
a current sensing circuit;
a voltage regulation circuit; and
a male connector comprised of a conductive interface and a digital communication interface.

8. The cordless battery-powered kitchen appliance system of claim 7 further comprised of a second charging station comprised of a second fastener that attaches to the first fastener to allow the second charging station to attach to the first charging station.

9. The cordless battery-powered kitchen appliance system of claim 7, wherein the second charging station is comprised of a second charging port comprised of a second attachment interface.

10. The cordless battery-powered kitchen appliance system of claim 7, wherein the second charging station is comprised of a second electrical connection interface that engages the first electrical connection interface of the first charging station.

11. The cordless battery-powered kitchen appliance system of claim 7, wherein the first charging station is comprised of a first display.

12. A cordless battery-powered kitchen appliance system comprising:
a first charging station comprised of:
a first charging port comprised of a first attachment interface;
a power supply interface configured to receive external power;
a first fastener;
a first electrical connection interface; and
a battery management module;
a rechargeable battery comprised of:
a housing;
a current sensing circuit;
a voltage regulation circuit; and
a male connector comprised of a conductive interface and a digital communication interface;
an appliance comprising:
a receiving area designed to receive the male connector of the rechargeable battery, wherein the receiving area is comprised of an electrical contact.

13. The cordless battery-powered kitchen appliance system of claim 12 further comprised of a second charging station comprised of a second fastener that attaches to the first fastener to allow the second charging station to attach to the first charging station.

14. The cordless battery-powered kitchen appliance system of claim 13, wherein the second charging station is comprised of a second charging port comprised of a second attachment interface.

15. The cordless battery-powered kitchen appliance system of claim 13, wherein the second charging station is comprised of a second electrical connection interface that engages the first electrical connection interface of the first charging station.

16. The cordless battery-powered kitchen appliance system of claim 12, wherein the first charging station is comprised of a first display.

17. The cordless battery-powered kitchen appliance system of claim 12, wherein the appliance is comprised of a kitchen appliance.

18. The cordless battery-powered kitchen appliance system of claim 12, wherein the appliance is comprised of a personal care device.

19. The cordless battery-powered kitchen appliance system of claim 12, wherein the appliance is comprised of a utility device.

20. The cordless battery-powered kitchen appliance system of claim 12, wherein the appliance is comprised of an outdoor device.
